(19) United States
(12) Patent Application Publication
(10) Pub. No.: US 2017/0101963 A1
(43) Pub. Date: Apr. 13, 2017

(54) METHOD AND A CIRCUIT FOR REGULATING A ROCKET ENGINE

(71) Applicant: AIRBUS SAFRAN LAUNCHERS SAS, Issy-Les-Moulineaux (FR)

(72) Inventors: Manuel KLEIN, Vernon (FR); David HAYOUN, Montreal (CA); Serge LE GONIDEC, Vernon (FR); Sebastien REICHSTADT, Asnieres Sur Seine (FR)

(73) Assignee: AIRBUS SAFRAN LAUNCHERS SAS, Issy-Les-Moulineaux (FR)

(21) Appl. No.: 15/288,521

(22) Filed: Oct. 7, 2016

(30) Foreign Application Priority Data
Oct. 8, 2015 (FR) 15 02103

(51) Int. Cl. F02K 9/58; F02K 9/62; F02K 9/46

(52) U.S. Cl. CPC F02K 9/58; F02K 9/46; F02K 9/62; F05D 2220/80; F05D 2240/24

(57) ABSTRACT

The invention relates to the field of rocket engines, and in particular to a method and a circuit for regulating a rocket engine (1) comprising at least one combustion chamber (3) and a first liquid propellant feed circuit (10) with a first pump (12) for pumping a first liquid propellant and a first turbine (14) for actuating the first pump (12), a first feed valve (15), and a regulator device for regulating the first turbine (14). In the regulation method and circuit, an opening command (DVCH) for opening the first feed valve (15) is calculated from an external command (Cₑₓₜ) in application of an open loop control relationship; a command for the regulator device of the first turbine (14) is calculated on the basis of said external command (Cₑₓₜ) and at least one feedback value, in application of a closed loop control relationship; and the first feed valve (15) and the regulator device of the first turbine (14) are controlled in application of the respective commands.

### BACKGROUND OF THE INVENTION

The present invention relates to the field of rocket engines having at least one liquid propellant, and it relates more precisely to regulating them.

The term “rocket engine” is used herein to mean any anaerobic reaction engine suitable for generating thrust by expanding and accelerating a high-enthalpy gas in a nozzle, and in particular in a convergent-divergent nozzle. Rocket engines include in particular chemical rocket engines, in which the high-enthalpy gas is generated by a chemical reaction in at least one combustion chamber upstream from the nozzle. Such chemical rocket engines may be solid propellant rockets, with the high-enthalpy gas being generated by a chemical reaction of at least one propellant. It is thus possible to understand that the term “rocket engine having at least one liquid propellant” covers a chemical rocket engine having a single liquid propellant, a plurality of liquid propellants, or that is hybrid. In such a rocket engine having at least one liquid propellant, it is possible in principle to regulate the generation of high-enthalpy gas, and thus of thrust, by means of the liquid propellant feed(s) to the combustion chamber. Several alternatives are known for providing such feed(s), including in particular feed by means of a turbopump, in which the combustion chamber of the rocket engine is fed at least with a first propellant via a first liquid propellant feed circuit having a first pump for feeding the combustion chamber with a liquid propellant and a first turbine for driving the first pump.

In the field of rocket engines, it is being increasingly sought to be able to adjust thrust over a wide range of values, e.g. 20% to 100% of nominal thrust. With space launchers, for example, that makes it possible to increase the versatility of launchers, in particular for multiple launches, and also to increase their economic efficiency. On satellites or orbital transfer vehicles, such an enlarged range of thrust enables the lifetime of vehicles to be extended, thereby also achieving very favorable economic spin-offs.

Nevertheless, such adjustment typically makes use of regulation methods and circuits that are relatively complex, requiring a large number of valves and other devices for controlling the feed to the combustion chamber of at least one liquid propellant. This can require considerable computation power, which is difficult to achieve with the limited means on board such a vehicle, and which also makes regulation vulnerable to a failure in any of the multiple regulator devices.

### OBJECT AND SUMMARY OF THE INVENTION

The present disclosure thus seeks to remedy those drawbacks by proposing a method that makes it possible in simple and robust manner to regulate the operation of a rocket engine comprising at least one combustion chamber and a first liquid propellant feed circuit with a first pump for pumping a first liquid propellant and a first turbine for actuating the first pump, a first feed valve, and a regulator device for regulating the first turbine.

In at least one implementation, this object is achieved by the fact that the regulation method comprises the following steps:
calculating an opening command for opening the first feed valve from an external command, in application of an open loop control relationship;
calculating a command for the regulator device of the first turbine on the basis of said external command and of at least one feedback value, in application of a closed loop control relationship; and
controlling the first feed valve and the regulator device of the first turbine in compliance with the respective commands.

By means of these provisions, the closed loop control of the first turbine serves to correct errors due to open loop control of the first feed valve, thus enabling the rocket engine to be regulated accurately even while using relatively small amounts of computation power and while acting on a limited number of regulator devices.

The regulation method is particularly applicable to an expander cycle rocket engine in which said first feed circuit includes a heat exchanger for heating the first liquid propellant downstream from the first pump, and then passes through the first turbine downstream from the heat exchanger in order to drive the first pump by causing the first liquid propellant as heated in the heat exchanger to expand in the first turbine. Nevertheless, it is also applicable to other types of rocket engine, such as for example gas generator rocket engines, having a gas generator to feed at least the first turbine with hot combustion gas. Under such circumstances, the regulator device of the first turbine may in particular include at least one feed valve of the gas generator. Furthermore, the term “gas generator” should be understood broadly, covering any device for performing total or partial combustion and capable of generating hot combustion gas, including a combustion prechamber in a staged-combustion rocket engine.

Independently of whether the rocket engine is an expander-type rocket engine, a gas generator rocket engine or a rocket engine of some other type, the regulator device of the first turbine may in particular comprise a bypass valve for bypassing the first turbine. Such a bypass valve thus enables the driving fluid flow passing through the turbine to be regulated and thus makes it possible indirectly to regulate the flow rate of the first propellant pumped by the first pump and thus delivered to the combustion chamber via the first feed valve.

Said external command may in particular comprise a command value for the gas pressure in the combustion chamber. Under such circumstances, at least one feedback value may then comprise a measured value of the gas pressure in the combustion chamber, so that the closed loop control relationship corrects an error between the command value and the measured value. Nevertheless, it is also possible to envisage using an estimated value, instead of a measured value, as the feedback value.

In order to limit the stresses exerted on the first feed valve and/or the regulator device of the first turbine, the method may also include a step of filtering the external command in a tracking filter, and the command for opening the first feed valve of the combustion chamber may then be calculated on the basis of the external command as filtered in this filtering step, and/or the command for the regulator device of the first turbine may be calculated by a disturbance corrector on the basis of at least one feedback value and of the external command as filtered in this filtered step, the disturbance corrector having a cutoff frequency that is higher than that of the tracking filter.

Although the regulation method can be used for regulating a single propellant rocket engine or a hybrid rocket engine, in which the combustion chamber is thus fed with only one liquid propellant, it is also applicable to a rocket engine that also has a second liquid propellant feed circuit for feeding a second liquid propellant. Said external command may then comprise a command value for the ratio between a flow rate of the first propellant and a flow rate of the second propellant. Under such circumstances, at least one feedback value may comprise a measured value of the ratio of the flow rate of the first propellant and the flow rate of the second propellant, which ratio may then be compared with its command value in the closed loop for regulating the first turbine.

The second liquid propellant feed circuit may in particular include a second feed valve, and the regulation method may then include a step of calculating an opening command for opening the second feed valve on the basis of the external command in application of an open loop control relationship, with the second feed valve being controlled in application of this opening command.

Furthermore, although it is possible to envisage other means for establishing a flow of the second propellant, such as for example a pressurized tank, the second liquid propellant feed circuit may in particular include a second pump for the second liquid propellant. This second pump may be actuated by the first turbine or by other means that can be envisaged by the person skilled in the art, however one particularly appropriate option is for the rocket engine to have a second turbine for driving the second pump. Under such circumstances, the rocket engine may further comprise a regulator device for regulating the second turbine, and the regulation method also includes calculating a command for the regulator device of the second turbine on the basis of said external command and of at least one feedback value in application of a closed loop control relationship, and controlling the regulator device of the second turbine in application of this command for the regulator device of the second turbine. The flows of both of the propellants are thus regulated in analogous manner. The regulator device of the first turbine and the regulator device of the second turbine may even be a single device and/or may share certain elements.

The present disclosure also provides a circuit for regulating a rocket engine having at least one liquid propellant, said rocket engine comprising at least one combustion chamber and a first liquid propellant feed circuit with a first pump for pumping a first liquid propellant and a first turbine for actuating the first pump, a first feed valve, and a regulator device for regulating the first turbine. In at least one embodiment, the regulator circuit comprises an open loop for controlling at least the first feed valve, and including a module for calculating a command for opening the first feed valve of the combustion chamber on the basis of an external command; and a closed loop for controlling the first turbine, with a module for calculating a command for the regulator device of the first turbine on the basis of said external command and of at least one feedback value.

Furthermore, this disclosure also relates to a rocket engine fitted with such a regulator circuit and to software and/or a data medium containing instructions for executing the regulation method in a programmable electronic control unit. The term “data medium” covers any medium enabling data to be stored in durable and/or in transient manner, subsequently to be read by a computer system. Thus, the term “data medium” covers, amongst other things, magnetic tapes, magnetic and/or optical disks, and solid state electronic memories, which may be volatile or non-volatile.

### BRIEF DESCRIPTION OF THE DRAWINGS

The invention can be well understood and its advantages appear better on reading the following detailed description of embodiments shown as non-limiting examples. The description refers to the accompanying drawings, in which:

FIG. 1 is a diagrammatic view of a two-propellant rocket engine using an expander cycle, in an embodiment of the invention;

FIG. 2 is a functional diagram of a regulator circuit for the FIG. 1 rocket engine;

FIG. 3 is a diagrammatic view of a two-propellant rocket engine with staged combustion; and

FIG. 4 is a functional diagram of a regulator circuit for the FIG. 3 rocket engine.

### DETAILED DESCRIPTION OF THE INVENTION

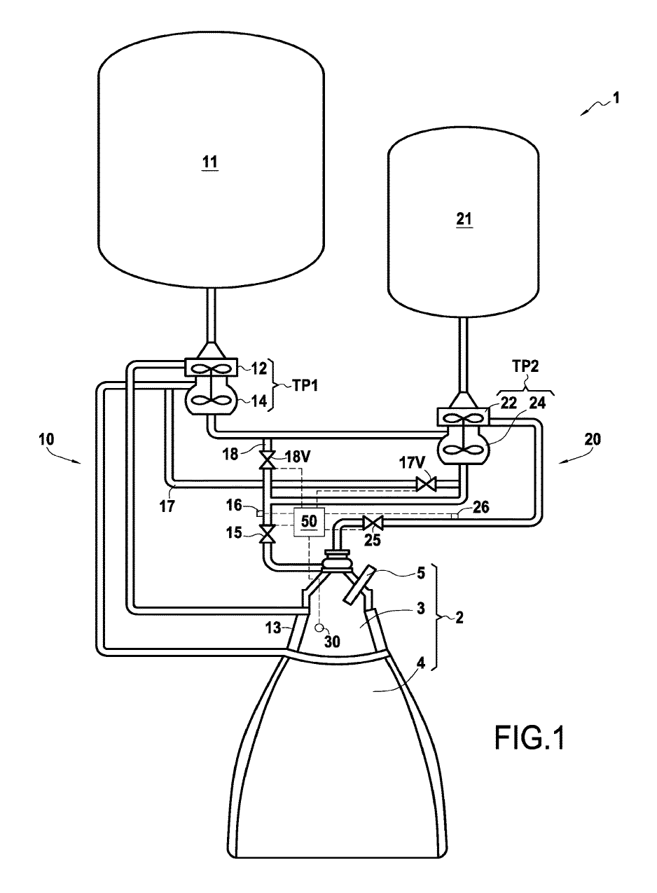

FIG. 1 is a diagram showing an expander cycle rocket engine 1 of the kind that may be incorporated by way of example in a rocket launcher stage, in an orbit transfer vehicle, or in some other space vehicle.

The rocket engine 1 comprises a propulsion chamber 2, a first feed circuit 10, a second feed circuit 20, and an electronic control unit 50. The propulsion chamber 2 comprises a combustion chamber 3, an igniter 5, and a nozzle 4 for expanding and supersonically ejecting high-enthalpy gas generated by combustion of a mixture of first and second liquid propellants in the combustion chamber 3. The first feed circuit 10 connects a first tank 11 that contains the first liquid propellant to the propulsion chamber 2 in order to feed the combustion chamber 3 with the first liquid propellant. The second feed circuit 20 connects a second tank 21 containing the second liquid propellant to the propulsion chamber 2 in order to feed the combustion chamber 3 with the second liquid propellant.

In the embodiment shown, the first feed circuit 10 comprises, in succession in the flow direction of the first propellant from the first tank 11 to the inside of the combustion chamber 3: a first pump 12; a heat exchanger 13; a first turbine 14; a second turbine 24; and a first feed valve 15 of the combustion chamber 3. The second feed circuit 20 comprises, in succession in the flow direction of the second propellant from the second tank 21 to the inside of the combustion chamber 3: a second pump 22; and a second feed valve 25 of the combustion chamber 3. Furthermore, first and second flow rate sensors 16 and 26 are installed respectively in the first and second feed circuits 10 and 20 in order to measure the (volume or mass) flow rate of each of the propellants delivered to the combustion chamber. In the embodiment shown, the flow rate sensors 16 and 26 are situated directly upstream from the feed valves 15 and 25 of the combustion chamber, however it is also possible to consider other positions as alternatives and also other means for obtaining these magnitudes, such as an estimator or a model. Furthermore, a pressure sensor 30 is installed inside the combustion chamber 3.

The heat exchanger 13 is formed by at least one wall of the propulsion chamber 2, so as to heat the first propellant with heat from the combustion of the propellants in the combustion chamber 3, while also cooling the wall. The first turbine 14 is mechanically coupled to the first pump 12, thereby forming a first turbopump TP1. Furthermore, the second turbine 24 is mechanically coupled to the second pump 22, thereby forming a second turbopump TP2. In this way, after the first propellant has been heated in the heat exchanger 13, a first partial expansion of the first propellant in the first turbine 14 serves to drive the first pump 12 and feed the combustion chamber 3 with the first propellant, and a second partial expansion of the first propellant may then drive the second pump 22 in order to feed the combustion chamber 3 with the second propellant. Furthermore, the first feed circuit 10 also has a bypass branch 17 for bypassing the first and second turbines 14 and 24, this branch including a bypass valve 17v for bypassing the first and second turbines 14 and 24, and the first circuit also has a bypass branch 18 for bypassing the second turbine 24 with a bypass valve 18v for bypassing the second turbine 24. The bypass valves 17v, 18v thus form devices for regulating the first and second turbines 14 and 24.

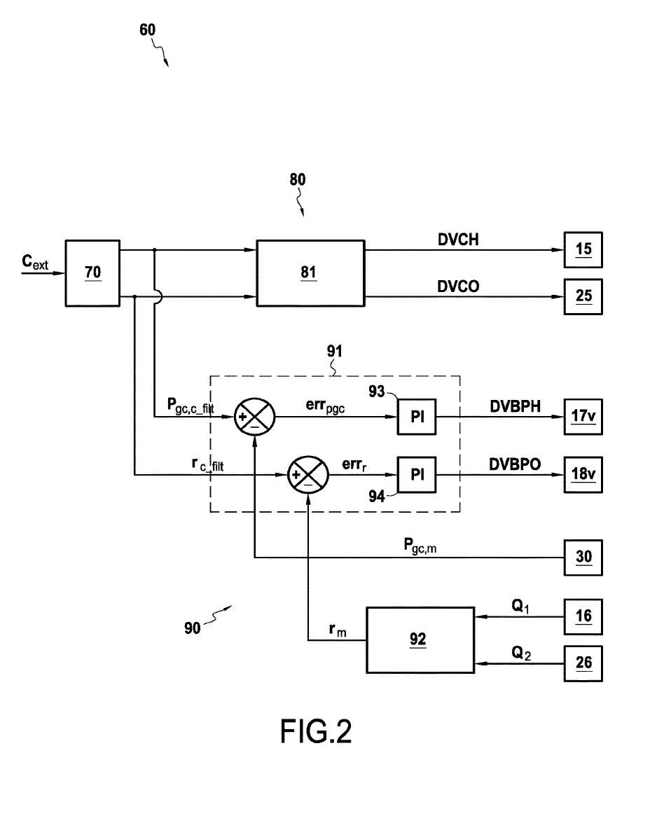

In the embodiment shown, the flow rate sensors 16 and 26 and the pressure sensor 30, and also the feed valves 15 and 25 and the bypass valves 17v and 18v are all connected to the electronic control unit 50 in order to form a regulator circuit 60 for regulating the rocket engine 1, which circuit is shown in FIG. 2. In particular, this electronic control unit 50 may comprise in particular a digital computer operating at a predetermined sampling rate.

As shown in FIG. 2, the regulator circuit 60 may comprise a tracking filter 70 upstream from an open loop 80 for controlling the feed valves 15 and 25, and a closed loop 90 for controlling the turbines 14 and 24. The tracking filter 70 may in particular be a first order or a second order tracking filter. Although in the embodiment shown the filter is common to both loops 80 and 90, it is also possible to envisage having a tracking filter specific to each loop. The filter is for filtering an external command Cₑₓₜ comprising command values p_{gc,c}_{_}ₑₓₜ and r_{c}_{_}ₑₓₜ relating respectively to gas pressure in the combustion chamber 3 and to a flow rate ratio between the two propellants, thus resulting in a filtered external command C_{filt} with filtered command values p_{gc,c}_{_}_{filt} and r_{c}_{_}_{filt}. The tracking filter 70 may in particular be a first order digital filter using the formula:

C_{filt}(k)−K_{filt1}C_{filt}(k−1)+K_{filt2}Cₑₓₜ(k−1)

where each of the filtered command values p_{gc,c}_{_}_{filt} and r_{c}_{_}_{filt} at a sampling instant k corresponds to adding the filtered command values p_{pc,c}_{_}_{filt} and r_{c}_{_}_{filt} corresponding to the preceding sampling instant k−1 as multiplied by a first predetermined constant K_{filt1}, and the corresponding command values p_{gc,c}_{_}ₑₓₜ and r_{c}_{_}ₑₓₜ at the instant k−1 likewise multiplied by a second predetermined constant K_{filt2}. For example, for an engine that is to have a minimum response of 3 seconds (s), with a sampling rate of 10 milliseconds (ms), the value of K_{filt1} may be 0.99005 and the value of K_{filt2} may be 0.00995.

The open loop 80 comprises a first calculation module 81 connected to the tracking filter 70 in order to calculate commands DVCO and DVCH for opening the feed valves 15 and 25 of the combustion chamber 3 on the basis of the filtered external command C_{filt}. This calculation module 81 may be configured in particular to apply polynomial control relationships, such as those given by the following equations:

DVCO=K₁X⁴+K₂X³+K₃X²+K₄X+K₅

DVCH=K₆X⁴+K₇X³+K₈X²+K₉X+K₁₀

in which K₁ to K₁₀ are predetermined coefficients and x is a ratio between the filtered command value for gas pressure p_{gc,c}_{_}_{filt} and a predetermined maximum value p_{gc,max} for the gas pressure in the combustion chamber.

Nevertheless, other types of control relationship can also be envisaged, such as for example a control relationship relying on an artificial neural network. The calculation module 81 is connected to actuators of the feed valves 15 and 25 for the combustion chamber 3 in order to transmit the opening commands DVCO and DVCH thereto, which commands correspond to a ratio between the movement of each actuator from a closed position of the corresponding valve to its total stroke between the closed position and a maximally open position of the valve.

The closed loop 90 includes a divider module 92, possibly with protection against division by 0, and a calculation module 91 connected to the tracking filter 70, to the pressure sensor 30, and via the divider module 92, to the flow rate sensors 16 and 26 in order to calculate commands DVBPH and DVBPO for opening the bypass valves 17v and 18v on the basis of the filtered external command C_{filt} and of feedback values comprising a gas pressure value p_{gc,m} measured by the pressure sensor 30 and a ratio rₘ between a flow rate Q₁ measured by the flow rate sensor 16 and a flow rate Q₂ measured by the flow rate sensor 26. The calculation module 91 has a cutoff frequency that is higher than that of the tracking filter 70, and may for example be in the form of a dual proportional integral disturbance corrector such as that shown in FIG. 2, with a first proportional integral corrector 93 for generating the command DVBPH for opening the bypass valve 17v on the basis of the error err_{pgc} between the filtered command value for gas pressure p_{gc,c}_{_}_{filt} and the gas pressure value p_{gc,m} as measured by the pressure sensor 30, and a second proportional integral corrector 94 for generating the command DVBPO for opening the bypass valve 18v on the basis of the error errᵣ between the filtered command valve for the propellant flow rate ratio r_{c}_{_}_{filt} and the ratio rₘ between the flow rate Q₁ measured by the flow rate sensor 16 and the flow rate Q₂ measured by the flow rate sensor 26, in application of the following formulas:

DVBPH(k)=DVBPH(k−1)−Kₚ₁err_{pgc}(k)+Kₚ₁err_{pgc}(k−1)−Kᵢ₁Tₑerr_{pgc}(k−1)

DVBPO(k)=DVBPO(k−1)−Kₚ₂errᵣ(k)+Kₚ₂errᵣ(k−1)−Kᵢ₂Tₑerrᵣ(k−1)

in which DVBPH(k) and DVBPO(k) are the respective command values DVBPH and DVBPO at the sampling instant k, DVBPH(k−1) and DVBPO(k−1) are the values of the same commands at the preceding sampling instant k−1, err_{pgc}(k) and errᵣ(k) are the values of the respective errors err_{pgc} and errᵣ at the sampling instant k, err_{pgc}(k−1) and errᵣ(k−1) are the values of the same errors at the preceding sampling instant, Kₚ₁ and Kₚ₂ are the proportional constants respectively of the first and second proportional integral correctors 93 and 94, Kᵢ₁ and Kᵢ₂ are their respective integral constants, and Tₑ is the sampling rate of the calculation module 91. By way of example, the proportional constants Kₚ₁ and Kₚ₂ may have respective values of 8.1 per megapascal (MPa⁻¹) and 90 MPa⁻¹, and the integral constants Kᵢ₁ and Kᵢ₂ may have respective values of 54 per megapascal-second (MPa⁻¹s⁻¹) and 6000 MPa⁻¹s⁻¹ with a sampling rate Tₑ of 10 ms.

Nevertheless, the calculation module 91 may alternatively have other forms, e.g. such as the form of a multivariable corrector, and in particular a corrector using a predictive internal model.

In operation, the first liquid propellant, which may in particular be a cryogenic fluid such as liquid hydrogen, is extracted from the first tank 11 and pumped by the first pump 12 through the first feed circuit 10 to the combustion chamber 3. In the heat exchanger 13, the first liquid propellant is heated, thereby increasing its enthalpy. A fraction of this additional enthalpy is then used to drive the first pump 12 and the second pump 22 by partial expansion at least of respective fractions of the flow rate of the first liquid propellant passing through the first turbine 14 and through the second turbine 24. The bypass ducts 17 and 18 with their respective bypass valves 17v and 18v serve to regulate the proportion of the total flow of the first liquid propellant that passes through each of the two turbines 14 and 24, and also to regulate the speeds of the two turbopumps TP1 and TP2. The total flow rate of the first liquid propellant then passes thorough the first feed valve 15 of the combustion chamber 3, thereby contributing to regulating said total flow rate, prior to being injected into the combustion chamber 3. The second liquid propellant, which may also be a cryogenic fluid, e.g. liquid oxygen, is extracted from the second tank 21 and is pumped by the second pump 22 through the second feed circuit 20, including the second feed valve 25 of the combustion chamber 3 so as to be injected into the combustion chamber 3. The second feed valve 25 contributes to regulating its flow rate.

The two propellants, mixed within the combustion chamber 3, enter into combustion giving off a large amount of heat, thereby generating high-enthalpy combustion gas, which, by expanding and accelerating up to supersonic speed in the nozzle 4, produces thrust in the opposite direction. Simultaneously, a fraction of the heat given off by the combustion of the propellants contributes to heating the first liquid propellant flowing through the heat exchanger 13.

The thrust thus produced by the rocket engine 1 depends in particular on the gas pressure p_{gc,m} in the combustion chamber, and on the gas temperature, and thus indirectly on the flow rates Q₁ and Q₂ of two propellants. These values are measured by the flow rate sensors 16 and 26, and by the pressure sensor 30, and they are transmitted to the electronic control unit 50.

In the electronic control unit 50, the tracking filter 70 filters the external command Cₑₓₜ comprising the command values p_{gc,c}_{_}ₑₓₜ and r_{c}_{_}ₑₓₜ, and it transmits the filtered external command C_{filt} to the open loop 80 for controlling the feed valves 15 and 25 and to the closed loop 90 for controlling the turbines 14 and 24. By way of example, this external command Cₑₓₜ may follow a preprogrammed profile stored in an internal memory of the electronic control unit 50 in order to track a programmed profile, and it may be calculated in flight by the electronic control unit 50 as a function of flight data of the vehicle propelled by the rocket engine 1, or it may be transmitted to the vehicle from a base station.

In the open loop for controlling the feed valves 15 and 25, the first calculation module 81 connected to the tracking filter 70 calculates the commands DVCO and DVCH for opening the feed valves 15 and 25 of the combustion chamber 3 on the basis of the filtered external command C_{filt}. These opening commands DVCO and DVCH are then transmitted to the actuators of the feed valves 15 and 25 in order to control the feed of propellants to the combustion chamber 3, and thus control the rate at which the rocket engine 1 operates.

The closed loop 90 for controlling the turbines 14 and 24 serves to obtain more accurate regulation of this rate of operation. In this closed loop, the filtered command values p_{gc,filt} and r_{filt} of the filtered external command C_{filt} are compared with the respective measured values p_{gc,m} and rₘ in order to obtain the corresponding errors err_{pgc} and errᵣ, on the basis of which the calculation module 91 calculates the commands DVBPH and DVBPO for opening the bypass valves 17v and 18v. These opening commands DVBPH and DVBPO are then transmitted to the actuators of the bypass valves 17v and 18v in order to regulate the speeds of the turbines 14 and 24, and in order to correct departures of the rate of operation of the rocket engine from the external command Cₑₓₜ.

The electronic control unit 50, and in particular the calculation module 81 of the open loop 80 may be configured in such a manner that the commands DVBPH and DVBPO for opening the bypass valves 17v and 18v in the closed loop 90 remain within a range 20% to 80% of fully open. In particular, this may be achieved by appropriately selecting the coefficients K₁ to K₁₀.

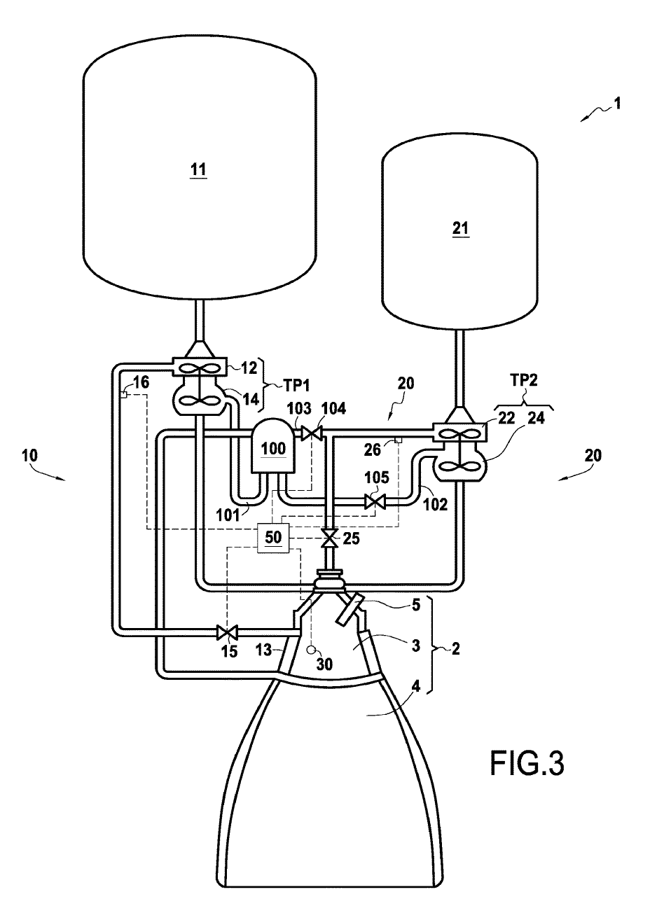

Although in this first embodiment, the regulation method and system serves to regulate the operation of an expander type rocket engine, it is also possible to envisage adapting them to regulating other types of rocket engine, such as for example the staged combustion rocket engine shown in FIG. 3.

This rocket engine 1 also has a propulsion chamber 2, a first feed circuit 10, a second feed circuit 20, and an electronic control unit 50. The propulsion chamber 2 comprises a combustion chamber 3, an igniter 5, and a nozzle 4 for expanding and supersonically ejecting high-enthalpy gas generated by combustion in the combustion chamber 3. The first feed circuit 10 connects a first tank 11 containing the first liquid propellant to a gas generator 100 forming a combustion prechamber in order to feed this gas generator 100 with the first liquid propellant. The second feed circuit 20 connects a second tank 21 containing the second liquid propellant to the propulsion chamber 2 and to the gas generator 100 in order to feed the combustion chamber 3 and the gas generator 100 with the second liquid propellant. Finally, ducts 101 and 102 connect the gas generator 100 to the propulsion chamber 2 in order to supply the combustion chamber with the gas that results from partial combustion in the gas generator 100 of a mixture of said first and second propellants, which mixture is rich in the first propellants.

In this second embodiment, the first feed circuit 10 comprises in succession in the flow direction of the first propellant: a first pump 12; a first feed valve 15; and a heat exchanger 13. The first feed circuit 10 also includes, for driving the first pump 12, a first turbine 14 having the duct 101 passing therethrough. The second feed circuit 20 comprises, in succession in the flow direction of the second propellant: a second pump 22; and a second feed valve 25. For the purpose of driving the second pump 22, it also has a second turbine 24 with the duct 102 passing therethrough, and a branch connection 103 having a valve 104 for feeding the gas generator 100. Furthermore, first and second flow rate sensors 16 and 26 are installed respectively in the first and second feed circuits 10 and 20 in order to measure the (volume or mass) flow rates of each of the propellants delivered to the combustion chamber. In this second embodiment, these flow rate sensors 16 and 26 are situated directly downstream from the pumps 12 and 22, however other positions could also be envisaged as alternatives as can other means for obtaining these magnitudes, such as an estimator or a model. In addition, a pressure sensor 30 is installed inside the combustion chamber 3.

The heat exchanger 13 is formed on at least one wall of the propulsion chamber 2 so as to heat the first propellant by means of the heat of combustion of the propellants in the combustion chamber 3, while also cooling this wall. The first turbine 14 is mechanically coupled to the first pump 12, thus forming a first turbopump TP1. Furthermore, the second turbine 24 is mechanically coupled to the second pump 22, thus forming a second turbopump TP2. Thus, partial combustion in the gas generator 100 of the first propellant with some of the second propellant taken from a main flow of the second propellant between the second pump 22 and the second valve 25 serves to generate a gas mixture that is rich in the first propellant, with a first fraction of that mixture flowing from the gas generator 100 to the propulsion chamber 2 via the first duct 101 being suitable for driving the first pump 12 by partially expanding in the first turbine 14 in order to cause the first propellant to flow, while a second fraction flowing in parallel from the gas generator 100 to the propulsion chamber 2 via the second duct 102 can drive the second pump 22 by partial expansion in the second turbine 24 in order to cause the second propellant to flow. Furthermore, the assembly also has a valve 105 installed in the duct 102. The valves 104 and 105 thus form means for regulating the turbines 14 and 24.

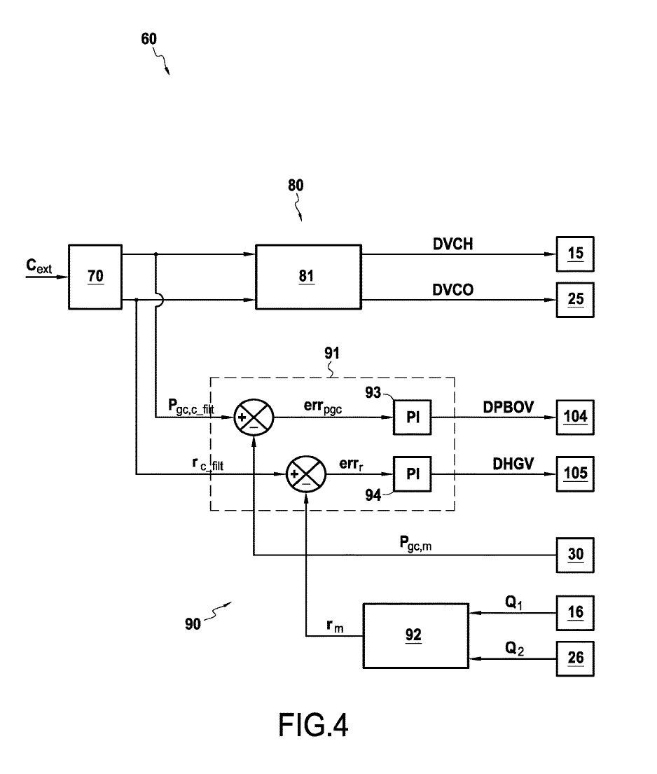

In this second embodiment, the flow rate sensors 16 and 26 and the pressure sensor 30, together with the valves 15, 25, 104, and 105 are all connected to the electronic control unit 50 in order to form the regulator circuit 60 of the rocket engine 1, which circuit is shown in FIG. 4. As in the first embodiment, the electronic control unit 50 in this second embodiment may likewise comprise a digital computer operating at a predetermined sampling rate.

The regulator circuit 60 in this second embodiment is broadly analogous to the circuit of the first embodiment, and it differs from it mainly in that its closed loop 90 regulates the operation of the turbines 14 and 24 by using the valves 104 and 105 instead of by using bypass valves. For this purpose, the calculation module 91 calculates commands DPBOV and DHGV for opening the valves 104 and 105 analogously to the commands DVBPH and DVBPO of the first embodiment. The other elements in this second embodiment are equivalent to those of the first embodiment and they are given the same references in the drawing.

Although the present invention is described with reference to specific implementations, it is clear that various modifications and changes may be made to these embodiments without going beyond the general ambit of the invention as defined by the claims. In addition, individual characteristics of the various implementations mentioned may be combined in additional implementations. Consequently, the description and the drawings should be considered in a sense that is illustrative rather than restrictive.

1. A method of regulating a rocket engine having at least one liquid propellant, said rocket engine comprising at least one combustion chamber and a first liquid propellant feed circuit with a first pump for pumping a first liquid propellant and a first turbine for actuating the first pump, a first feed valve, and a regulator device for regulating the first turbine, the regulation method comprising the following steps:
calculating an opening command for opening the first feed valve from an external command, in application of an open loop control relationship;
calculating a command for the regulator device of the first turbine on the basis of said external command and of at least one feedback value, in application of a closed loop control relationship; and
controlling the first feed valve of the combustion chamber and the regulator device of the first turbine in compliance with the respective commands.

2. The method of regulating a rocket engine in accordance with claim 1, wherein said first feed circuit includes a heat exchanger for heating the first liquid propellant downstream from the first pump, and then passes through the first turbine downstream from the heat exchanger in order to drive the first pump by causing the first liquid propellant as heated in the heat exchanger to expand in the first turbine.

3. The method of regulating a rocket engine in accordance with claim 1, wherein the rocket engine further includes a gas generator for feeding at least the first turbine with hot combustion gas.

4. The method of regulating a rocket engine in accordance with claim 3, wherein the regulator device of the first turbine comprises at least one feed valve of the gas generator.

5. The method of regulating a rocket engine in accordance with claim 1, wherein the regulator device of the first turbine comprises a bypass valve for bypassing the first turbine.

6. The method of regulating a rocket engine (1) in accordance with claim 1, wherein said external command comprises a command value for the gas pressure in the combustion chamber.

7. The method of regulating a rocket engine in accordance with claim 6, wherein at least one feedback value comprises a measured value of the gas pressure in the combustion chamber.

8. The method of regulating a rocket engine according to claim 1, including a step of filtering the external command in a tracking filter in order to obtain a filtered external command, and wherein the command for opening the first feed valve is calculated on the basis of the filtered external command and/or the command for the regulator device for regulating the first turbine is calculated by a disturbance corrector on the basis of at least one feedback value and of the filtered external command, the disturbance corrector having a cutoff frequency that is higher than that of the tracking filter.

9. The method of regulating a rocket engine according to claim 1, wherein the rocket engine further comprises a second feed circuit for feeding a second liquid propellant.

10. The method of regulating a rocket engine according to claim 9, wherein said external command comprises a command value for the ratio between a flow rate of the first propellant and a flow rate of the second propellant.

11. The method of regulating a rocket engine according to claim 10, wherein said at least one feedback value comprises a measured value of the ratio between the flow rate of the first propellant and the flow rate of the second propellant.

12. The method of regulating a rocket engine according to claim 9, wherein the second liquid propellant feed circuit includes a second feed valve, and the method also includes a step of calculating an opening command for opening the second feed valve on the basis of the external command in application of an open loop control relationship, and controlling the second feed valve in application of this opening command.

13. The method of regulating a rocket engine according to claim 9, wherein the second liquid propellant feed circuit includes a second pump for said second liquid propellant.

14. The method of regulating a rocket engine according to claim 13, wherein the rocket engine includes a second turbine for driving the second pump and a regulator device for regulating the second turbine, and the method also includes calculating a command for the regulator device of the second turbine on the basis of said external command and of at least one feedback value in application of a closed loop control relationship, and controlling the regulator device of the second turbine in application of this command for the regulator device of the second turbine.

15. A circuit for regulating a rocket engine having at least one liquid propellant, said rocket engine comprising at least one combustion chamber and a first liquid propellant feed circuit with a first pump for pumping a first liquid propellant and a first turbine for actuating the first pump, a first feed valve, and a regulator device for regulating the first turbine, the circuit comprising:
an open loop for controlling the first feed valve, and including a module for calculating at least one command for opening the first feed valve on the basis of an external command; and
a closed loop for controlling the first turbine, with a module for calculating a command for the regulator device of the first turbine on the basis of said external command and of at least one feedback value; and wherein
the circuit is configured to control the first feed valve of the combustion chamber and the regulator device of the first turbine in application of respective commands.
